(19) United States
(12) Patent Application Publication
(10) Pub. No.: US 2022/0050765 A1
(43) Pub. Date: Feb. 17, 2022

(54) METHOD FOR PROCESSING LOGS IN A COMPUTER SYSTEM FOR EVENTS IDENTIFIED AS ABNORMAL AND REVEALING SOLUTIONS, ELECTRONIC DEVICE, AND CLOUD SERVER

(71) Applicant: HONGFUJIN PRECISION ELECTRONICS(TIANJIN)CO.,LTD., Tianjin (CN)

(72) Inventors: SHENG-CHUNG PAN, New Taipei (TW); TING-CHIEH LIN, New Taipei (TW)

(21) Appl. No.: 17/104,693

(22) Filed: Nov. 25, 2020

(30) Foreign Application Priority Data
Aug. 17, 2020 (CN) 202010827229.8

(51) Int. Cl. G06F 11/34; G06F 16/903; G06F 9/54; G06F 40/30

(52) U.S. Cl. CPC G06F 11/3476; G06F 40/30; G06F 9/542; G06F 16/90344

(57) ABSTRACT

A method for processing events logged as abnormal in a computer log includes collecting logs as to abnormal events of an electronic device, comparing such log with log data on a cloud server, determining whether the log data matches events logged as abnormal, and obtains log data if such log data matches information as to logged events identified as abnormal. The disclosure also provides an electronic device and a cloud server applying the method.

### FIELD

The subject matter herein generally relates to computer logging.

### BACKGROUND

Data centers deploy a lot of equipment, and each item of equipment in the data center will have log output. Even with the help of the generated logs, manual reviews still reduce efficiency. Because of the limitations of manual review, many log analysis tools have been derived. Existing log analysis tools collect system event logs and trigger warning messages when errors occur, but do not provide solutions.

Therefore, an improvement is desired.

### BRIEF DESCRIPTION OF THE DRAWINGS

Implementations of the present disclosure will now be described, by way of embodiments, with reference to the attached figures.

FIG. 1 is a schematic diagram of an embodiment of a log processing system of the present disclosure.

FIG. 2 is a block diagram of an embodiment of an electronic device of the present disclosure.

FIG. 3 is a block diagram of an embodiment of a first log processing device.

FIG. 4 is a block diagram of an embodiment of a cloud server of the present disclosure.

FIG. 5 is a block diagram of an embodiment of a second log processing device.

FIG. 6 is another schematic diagram of an embodiment of the log processing system.

FIG. 7 is a flowchart of an embodiment of a method of processing a log.

FIG. 8 is a flowchart of another embodiment of a method of processing the log.

FIG. 9 is a flowchart of another embodiment of a method of processing the log,

FIG. 10 is a flowchart of another embodiment of a method of processing the log.

FIG. 11 is a flowchart of another embodiment of a method of processing the log.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

The following examples illustrate an environment of method for processing a log and abnormal entries therein.

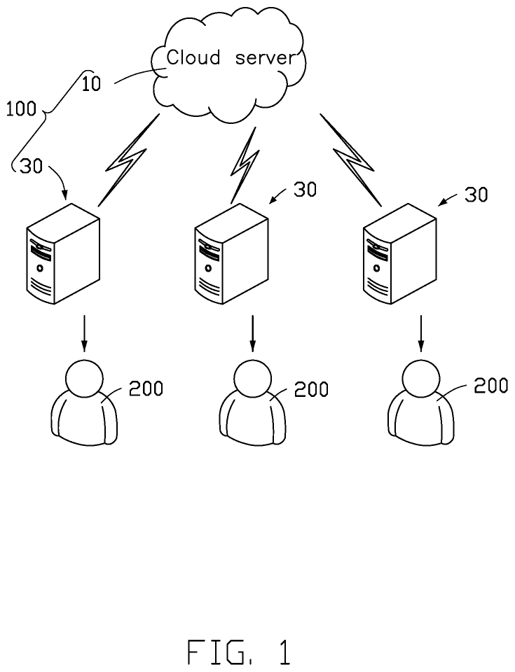

FIG. 1 illustrates a log processing system 100 in accordance with an embodiment of the present disclosure.

The log processing system 100 includes a cloud server 10 and a plurality of electronic devices 30. User 200 can operate the electronic devices 30, and the electronic devices 30 can access the cloud server 10 through communication network.

The electronic device 30 may be any type of smart device used to establish a communication connection with the cloud server 10, such as a mobile phone, a tablet computer, or a server. The electronic device 30 may be equipped with one or more different user interaction devices to collect instructions from the user 200 or display and feedback information to the user 200. These interactive devices include but are not limited to, buttons, display screens, touch screens, speakers, and remote control joysticks.

In the embodiment, the electronic device 30 may be a server in a data center (not shown). The data center is equipped with multiple server cabinets (not shown). Each server cabinet is equipped with multiple servers. The server is connected to the communication network, and the server can communicate with the cloud server through the communication network, to execute the log processing method.

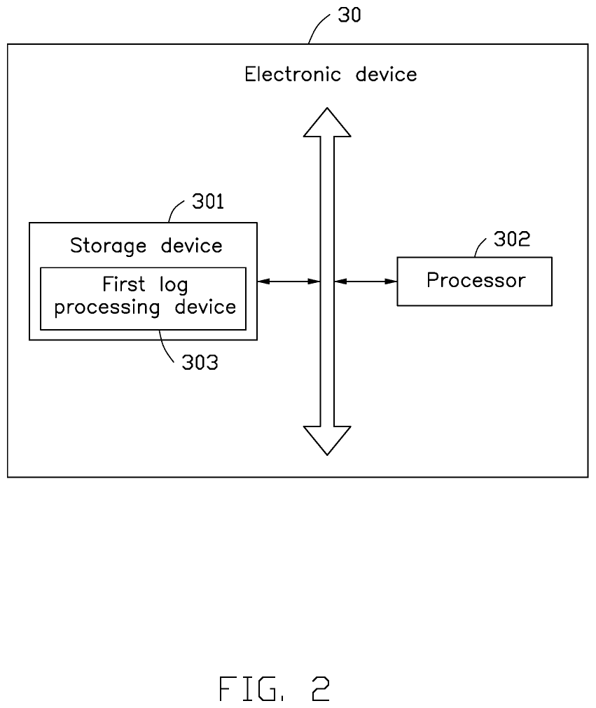

FIG. 2 illustrates that the electronic device 30 includes a storage device 301, at least one processor 302, and a first log processing device 303. The first log processing device 303 may be stored in the storage device 301 and run on the processor 302.

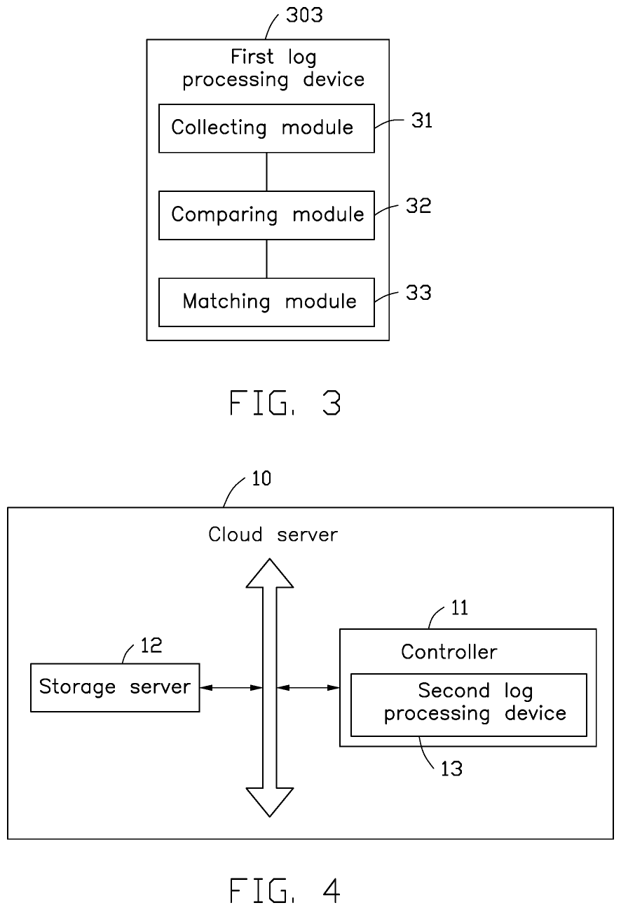

The first log processing device 303 may be implemented as a first log processing program. When the first log processing program is executed by the one or more processors 302, the one or more processors 302 are implemented by the steps in the embodiment of the method executed by the electronic device 30, or when the processor 302 executes the first program, the functions of the modules in FIG. 3 are implemented. The one or more modules may be a series of computer program instruction segments capable of completing specific functions, and the instruction segments are used to describe the execution process of the first log processing program in the first log processing device 303.

It should also be noted that, the schematic diagram is only an example of the electronic device 30 and does not constitute a limitation on the electronic device 30. The device 30 may include more or less components than those shown in the figure, or combine certain components, or have different components, for example, the electronic device 30 may also include an input display device, a communication module, a bus, etc.

In at least one embodiment, the processor 302 is a central processing unit (CPU), another general-purpose processor, a digital signal processor (DSPs), an application specific integrated circuit (ASIC), a Field-Programmable Gate Array (FPGA), another programmable logic device, a discrete gate, a transistor logic device, or a discrete hardware component, etc. The processor 302 may be a microprocessor, or the processor 302 may be any conventional processor. The processor 302 may use various interfaces and buses to connect various parts of the electronic device 30.

In some embodiments, the storage device 301 is used to store program code and various data. The storage device 301 can be used to store the first log processing program, the processor 302 implements various functions of the electronic device 30 by running or executing computer programs stored in the storage device 301, and calling up data stored in the storage device 301. In one embodiment, the storage device 301 may include random access memory, as well as non-volatile memory, such as hard drives, memory, plug-in hard drives, smart media card, secure digital, SD card, Flash Card, at least one disk memory, flash device.

The functional modules referred to in the present application refer to a series of program instruction segments that can be executed by the processor 302 of the electronic device 30 and can complete fixed functions, and are stored in the storage device 301 of the electronic device 30.

In the embodiment, the input display device (not shown) is a user interaction device, and a user interaction interface (not shown) is provided through the input display device. The user 200 can write data to the electronic device 30 through the user interaction interface, and the electronic device 30 can output data of the cloud server 10 to the user 200 through the user interaction interface.

FIG. 3 illustrates the first log processing device 303 in accordance with an embodiment of the present disclosure.

As shown in FIG. 3, the first log processing device 303 includes a collecting module 31, a comparing module 32, and a matching module 33. In one embodiment, the modules may be programmable software instructions that are stored in the storage device 301 and can be invoked and executed by the processor 302. It should also be noted that. in other embodiments, the modules may also be program instructions or firmware that are parsed and executed in the processor 302, that is, the first log processing device 303 may also be stored in the processor 302.

The collecting module 31 collects logs as to abnormalities of the electronic device according to preset log collection rule. In one embodiment, the preset log collection rule is a rule set by the user 200 according to need, so as to collect logged abnormalities that meet the conditions preset by the user 200 through the log collection rule. The collecting module 31 can collect logs that meet the preset log collection rule according to the preset log collection rule, and determine the log as being abnormal.

In one embodiment, the collecting module 31 can scan system logs of the electronic device 30 and detect event information. The system log includes a system event log, an application log, and a security log. Events generated by a controller 11 of the electronic device 30 are recorded in the system event logs.

In one embodiment, the comparing module 32 compares abnormal entries with log data on the cloud server 10, to determine whether there is log data that matches the logged abnormality. The log data includes one or more log descriptions of abnormalities and solutions uploaded by the electronic device 30 to the cloud server 10.

In one embodiment, the comparing module 32 can compare the abnormal entry with the log description on the cloud server 10, and can determine whether there is an abnormal entry description corresponding to the abnormality in the cloud server 10.

The matching module 33 obtains matched log data when there is log data that matches the logged abnormal entry.

In one embodiment, when there is an abnormality description corresponding to the abnormality, the matching module 33 reads the description of the solution and/or the corresponding solution script corresponding to the abnormality description from the cloud server 10.

The communication network can be based on any type of data transmission protocol. The communication network can be used to establish a wireless communication network for a data transmission channel between two nodes. For example, BLUETOOTH networks, WI-FI networks, wireless cellular networks or their combination in different signal frequency bands.

The cloud server 10 may be any type of the cloud server 10 in a network connection. After the cloud server 10 communicates with the electronic device 30, the cloud server 10 can provide services to the electronic device 30. The cloud server 10 may be a private cloud server or a public cloud server.

In the embodiment, the cloud server 10 is a hardware device or hardware component for providing computing services. When the cloud server 10 is a public cloud server, the electronic device 30 may be an electronic device 30 of a different company or organization, and the user 200 can be a user of a different company or organization. When the cloud server 10 is a private cloud server, the electronic device 30 is the electronic device of the same company or organization, and the user 200 is also the user 200 of the same company or organization.

FIG. 4 illustrates that the cloud server 10 can include a controller 11, a storage server 12, and a second log processing device 13. The storage server 12 is connected to the controller 11, and the second log processing device 13 is stored on the controller 11.

The storage server 12 is used to provide data access for the electronic device 30, the storage server 12 can be understood as a storage device 301 with a data storage function. For example, the storage server 12 stores the descriptions of logged entries and solutions uploaded by each electronic device 30, and the log descriptions and solutions uploaded by each of the electronic devices 30 can be obtained by accessing the storage server 12.

The controller 11 has logic processing capabilities and is mainly used to provide computer services for the storage server 12, and the controller 11 can be understood as the processor 302 of the cloud server 10. The second log processing device 13 may be regarded as a second log processing program, and the processor 302 implements the functions of each module in FIG. 5 when executing the second log processing program. Alternatively, when the controller 11 executes the second log processing program, the steps in the embodiment of the log processing method executed by the cloud server 10 are implemented.

The second log processing program may be divided into one or more modules, and the one or more modules are stored in the storage device 301 and executed by the processor 302. The one or more modules may be a series of computer program instruction segments capable of completing specific functions, and the instruction segments describe the execution process of the log processing program in the cloud server 10.

FIG. 5 illustrates the second log processing device 13 in accordance with an embodiment of the present disclosure. As shown in FIG. 5, the second log processing device 13 includes an obtaining module 101 and a response module 102.

The obtaining module 101 is used to obtain a service access request sent by the electronic device 30.

In the embodiment, the electronic device 30 sends a service access request to the cloud server 10, and the obtaining module 101 of the cloud server 10 obtains the service access request sent by the electronic device 30. In the embodiment, the response module 102 responds to the service access request and establishes a connection with the electronic device 30, to make the electronic device 30 write the log description of an abnormal entry and a solution and/or the electronic device 30 can read the log description and solution, In the embodiment, when the cloud server 10 succeeds in verification after the server access request, the cloud server 10 allows the electronic device 30 to use cloud services to establish a connection with the electronic device 30, and enables the>electronic device 30 to write a log description of an abnormal entry and solution and/or reads the log description and solution from the cloud server 10.

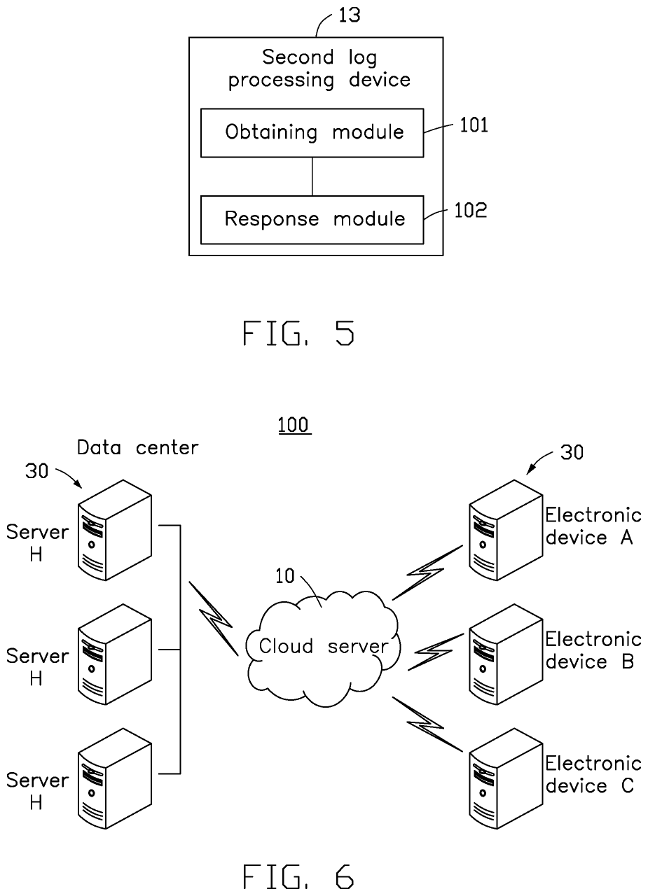

The working principle of the log processing system 100 in the described environment is described below. As shown in FIG. 6, the cloud server 10 is taken as an example of a public cloud server. In one embodiment, when servers of different companies, organizations or individuals detect logs as to abnormalities, they alert the user 200. The user 200 inputs the log description by the user 200, and the one or more solutions of the user 200 regarding the abnormal entry, or the script written by the user 200 to process the abnormality into the electronic device 30 through the user interactive device, the same then being uploaded to the cloud server 10 by the electronic device 30 through the communication network. Each user 200 can upload the log data to the cloud server 10 through the corresponding electronic device 30, in this way, it is possible to collect log information as to abnormalities and log processing experiences of various enterprises or various organizations or individuals through the cloud server 10.

As shown in FIG. 6, in the log processing system 100, the electronic device 30 may include the electronic device A of an organization, the electronic device B of an enterprise, and a personal electronic device C. The electronic device 30 sends a service access request to the cloud server 10.

After the controller 11 of the cloud server 10 in FIG. 4 successfully verifies the request, it establishes a connection between the cloud server 10 and the electronic device 30. Each user 200 writes log data to its corresponding electronic device 30 through the user interaction device, including the situation of each user encountering an abnormal log entry and a solution or a solution or a script for solving the problem. The electronic device 30 uploads the received log data to the storage server 12 of the cloud server 10 or the database of the storage server 12 through the communication network, the storage server 12 of the cloud server 10 stores the log data input by the user 200. and collects the experience of each user 200 in resolving abnormal entries through the cloud server 10.

Therefore, a large amount of data can be collected to analyze the abnormal entries and provide experience in problem solving. At the same time, the user 200 can obtain relevant experience data and even obtain scripts from the cloud server 10 through the electronic device 30. When the electronic device 30 automatically executes the scripts, it can quickly solve problems, reduce the cost of system maintenance, and save manpower.

It is should be noted that, in order to avoid leaks, what is uploaded to the cloud server 10 may only be the abnormal entry description, the solution to the logged entry, or the script written by the user 200 to process the abnormality. When the cloud server 10 is a private cloud service, the abnormal log can also be directly uploaded as a case, which is not specifically limited.

In the embodiment, when each server H in the data center of enterprise D executes the method, each server H in the data center automatically scans the system logs, including the system event log, the application log, and the security log. Events generated by the baseboard management controller (BMC) are recorded in the system event log. The system log may be a system log of a Windows operating system or a Linux operating system. The abnormal entries in the system log can be stored in the database or in the storage device 301 corresponding to the server ID, such as a local file server database, then comparison of the abnormal entry stored in the local file server database with the data of the database on the cloud server 10, to detect log data similar to the abnormal entry. When the log data similar to the abnormality is detected, the log data can be read to obtain corresponding experience. The local file server database of each server can automatically detect and monitor when the event log is uploaded, and record the writing of the abnormal event.

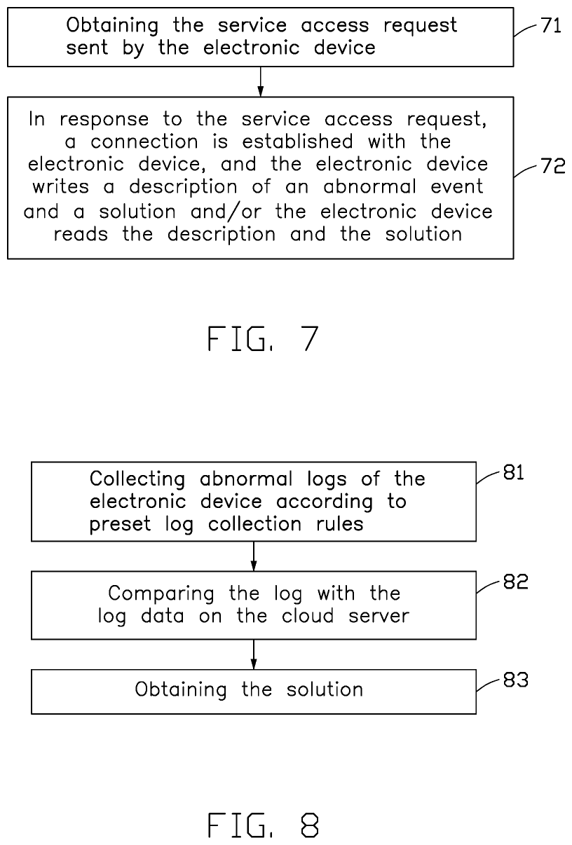

FIG. 7 illustrates a flowchart of a log processing method, the log processing method is applied to the cloud server 10, and the method may include the following steps.

In block 71, obtaining the service access request sent by the electronic device.

The service access request carries the device information and random sequence information of the electronic device 30. The device information is the unique identification of the electronic device 30, a terminal corresponds to only one piece of the device information, and the device information can be stored in the read-only memory (ROM of the electronic device 30. The random sequence information is used for verification, and the random sequence information may be a hash value, which is not specifically limited.

In block 72, in response to the service access request, a connection is established with the electronic device, and the electronic device writes a description of an abnormal event and a solution and/or the electronic device reads the description and the solution.

When the cloud server 10 verifies the device information and the random sequence information and the verification is successful, the cloud server 10 allows the electronic device 30 to use the cloud service. The cloud server 10 establishes a connection with the electronic device 30, so that the electronic device 30 can write log data or read log data.

FIG. 8 illustrates a flowchart of another embodiment of a log processing method, the log processing method is applied to the electronic device 30, and the method may include the following steps.

In block 81, collecting abnormal logs of the electronic device according to preset log collection rules.

In one embodiment, the preset log collection rule is a rule set by the user 200 according to need, so as to collect logs of abnormalities that meet the conditions preset by the user 200 through the log collection rule.

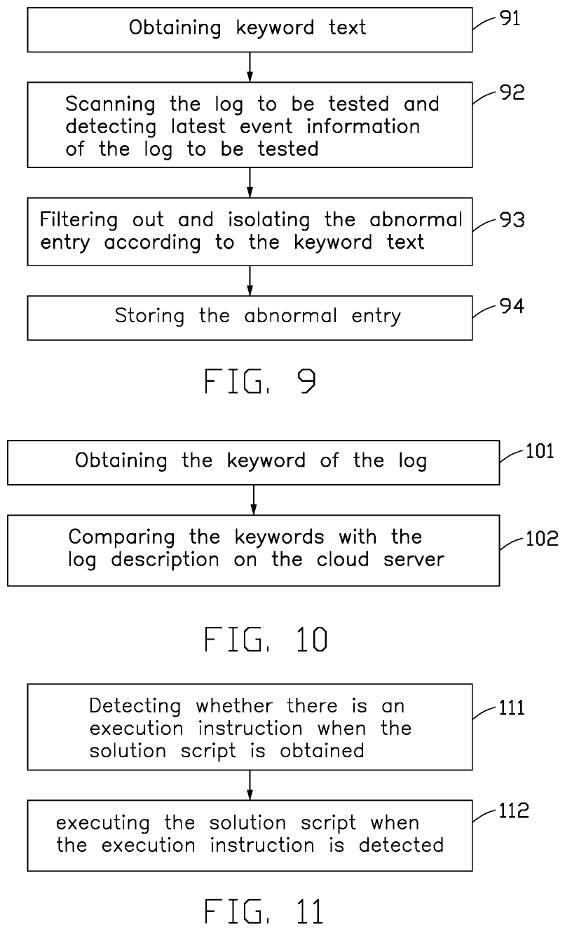

As shown in FIG. 9, in at least one embodiment, the block 81 can be implemented through the following steps.

In block 91, obtaining keyword text.

In the embodiment, the preset log collection rule can include the keyword text. The configuration by the user 200 is that when a keyword in the keyword text appears in the system log, the system log is determined to be an abnormal event. For example, when “error”, “fail” or “warning” appears in the system log, the system log will be determined as an abnormal event. For the BMC event log, when “correctable”, “uncorrectable”, “thermal” or “nmi” appears, the BMC event log is determined to be an abnormal event.

In block 92, scanning the log to be tested and detecting latest event information of the log to be tested.

In the embodiment, the log to be tested can include the system logs of Windows operating system or Linux operating system.

In the embodiment, the log to be tested is a system log of the electronic device 30. The system log can include a system event log, an application log, and a security log. Events generated by the baseboard management controller (BMC) of the electronic device 30 are recorded in the system event log.

In the embodiment, the operating system of the electronic device 30 can be Windows operating system or Linux operating system.

For example, in the data center, the operating system of each server may be incompatible. When the operating system of the server is a Windows operating system, the abnormal log can be scanned and collected by the following method: the system logs can be collected through a system log command line management tool such as wevtutil.exe that comes with the Windows operating system. When the operating system of the server is the Linux operating system, the system log can be scanned and collected by the following method: scan and read the system log through the log system on the Linux operating system, such as procedures involving the syslog protocol, syslog being a standard used to transmit log messages on the Internet protocol (TCP/IP) network. Or, the system log can be obtained through the program on the Linux operating system. For the BMC event log, a command line platform management tool such as ipmi (ipmitool) under the Linux operating system can be used to obtain the BMC event log.

In the embodiment, the information of the system logs changes in real time, and the system log information is updated in real time. It is necessary to detect the latest event information of the log to be tested, and the event information of the abnormal event stored in the subsequent steps is the current latest event information. In one embodiment, when scanning the system log, it is compared with the previous scan result to save the latest event log when the system log information is updated.

In the embodiment, the electronic device 30 can process not only logs of abnormal events, but also BMC event logs. The BMC event log is a log of abnormal entries, and the BMC event log on the electronic device 30 is processed according to the BMC event log information about the abnormal events stored on the cloud server 10.

In the embodiment, the cloud server 10 can process not only the system log of the Windows operating system, but also the system log of the Linux operating system. Processing of the system log of the Windows operating system is done according to the system log of the Windows operating system stored on the cloud server 10. Processing of the system log, of the Linux operating system is done according to the system log of the Linux operating system stored on the cloud server 10.

In block 93, filtering out and isolating the abnormal entry according to the keyword text.

In the embodiment, the event information of the log is the current latest event information.

In the embodiment, for each system log on the electronic device 30, the keyword text is compared line by line to detect whether the system log includes one or more keywords in the keyword text. When there are one or more keywords of the keyword file, the system log is filtered out, and the system log is determined to be an abnormal entry.

In block 94, storing the abnormal entry.

In the embodiment, store the selected entry in the storage device 301 corresponding to the ID of the electronic device 30 or the database on the storage device 301, for example, a local file server database.

Specifically, the keyword text is input into each of the electronic devices 30, input “automatic filtering keyword script”, and the electronic device 30 automatically filters according to the keyword text. The keyword text can be a txt file, including keywords such as “error”, “fail”, “warning”, “correctable”, “uncorrectable”, “thermal” or “nmi”. When the electronic device 30 executes the “automatic filter keyword script”, it will automatically scan the system log, and then filter the system log storing the keywords in the keyword text. After a first scan, the entry as to abnormality will be stored in the next scan and compared with the previous log to store the system log of the latest event.

In one embodiment, after the electronic device 30 performs block 81 to collect logged abnormalities according to the preset log collection rule, the electronic device 30 may alert the user 200 of the information, and the user 200 can process the abnormal event.

In one embodiment, when the electronic device 30 detects an abnormal event, it sends an alarm message to the user 200, and the user 200 can process the abnormality. The user 200 can click on the “problem and solution” window of the user interaction interface of the electronic device 30, to input the log description and solution for the daily log to the electronic device 30. For example, a brief description of the log event, including which system that has gone wrong.

The solution may be an analysis of the cause of the abnormal event, an idea of how to solve the abnormality, and the script for solving the abnormality. For the Windows operating system, the AutoIT language is used to develop Windows scripts. For the Linux operating system, the Shell scripting language is used to develop Linux scripts. Then the user 200 clicks “upload” on the user interaction interface, and after receiving the upload instruction of the user 200, the electronic device 30 uploads the log description and solution of the daily log to the cloud server 10 through the communication network. The cloud server 10 may be a private cloud server or a public cloud server.

In one embodiment, when the user 200 clicks on the “problem and solution” window of the user interaction interface of the electronic device 30, the user 200 can browse to the log description and solution uploaded to the cloud server 10 by other users 200, which can be specific to a certain log search for keywords, query related log processing experience, and evaluate the log processing experience.

For example, for the Windows system display error information (7000) event log, you can enter “Windows” and “7000” in the search box of the “Problems and Solutions” window. The user 200 searches for relevant experience, the electronic device 30 accesses the cloud server 10 according to the search term in the search box, and compares the title and log description on the cloud server 10, to detect the log where the match of the search term appears. The electronic device 30 reads the log description where the search term appears, and display it on the user interaction interface, and the user 200 can read all the log information related to such log on the cloud server 10. User 200 can evaluate each log description and solution to determine the best answer.

In the embodiment, the electronic device 30 that executes the first log processing program of the embodiment can upload the received log description and solution to the cloud server 10, by allowing the cloud server 10 to collect the processing experience of each enterprise, each organization, or each individual user 200 regarding logs of abnormalities.

After performing block 81, in contrast to the above-mentioned log processing by the user 200, the electronic device 30 may also perform block 82 to access the log data on the cloud server 10 through the electronic device 30, and obtain corresponding log handling experience.

In block 82, comparing the log with the log data on the cloud server.

In one embodiment, the log data includes one or more log descriptions and solutions uploaded by the electronic device to the cloud server.

As shown in FIG. 10, in at least one embodiment, the block 82 can be implemented through the following steps.

In block 101, obtaining the keyword of the log.

In block 102, comparing the keywords with the log description on the cloud server.

In the embodiment, the keywords of the log may overlap with the keywords in the keyword text, or may be inconsistent, and the keywords of the abnormal log may be set according to actual experience. The keywords of the logged abnormality are the keywords used by the user 200 when describing the log. For example, when user 200 describes a system event log: error (7000), recording its title as Windows system event log shows error message (7000), and its description is: due to the following error, the service cannot be started and the Windows system cannot be verified Index signature of this file. Then the words “Windows”, “warning”, and “7000” that appear frequently in the description can be keywords.

In the embodiment, after the keyword of the log is obtained, compare the log description on the cloud server 10 line by line according to the keywords, including the title of the log, content description, etc. The log data uploaded by the user 200 to the cloud service 10 may be the only event that occurred, the description of the logged event, and the solution.

In the embodiment, a fuzzy comparison method can be used to compare the keywords of the log line by line with the log title and log description, to filter out log data with the keywords, which is not specifically limited.

In block 83, obtaining the solution.

In the embodiment, when the comparison shows a match, obtain the corresponding solution description and/or the corresponding solution script.

FIG. 11 illustrates a flowchart of another embodiment of a log processing method, and the method may include the following steps.

In block 111, detecting whether there is an execution instruction when the solution script is obtained.

In block 112, executing the solution script when the execution instruction is detected.

In the embodiment, after the electronic device 30 determines log data which matches, by comparison with the cloud server 10, the electronic device 30 reads the matching log data and displays the log data. When the corresponding solution script is included in the log data, the user 200 is asked whether to execute the solution script. The user 200 can output an execution instruction on the user interaction interface after reading the solution script, and the electronic device 30 automatically executes the solution script after receiving the execution instruction.

In the embodiment, automatically collect Windows/Linux system event logs and BMC event logs through the cloud server 10, and then automatically store them in the database of the cloud server 10. The user manually sets the keyword text to automatically compare and filter out the matching system event log/BMC event log, allowing users to record how to troubleshoot the system and BMC event log. Upload the recorded information to the cloud server 10, by allowing the user to write a script of the solution and upload it to the database of the cloud server 10. Then automatically make comparison with the database of the cloud server 10, and automatically list the methods to solve the problem. The user can write or manipulate the logged event according to the listed problem-solving methods, or choose to execute the script in the listed problem-solving methods, and the electronic device 30 can execute the solution script by itself. It can also comment on the solutions provided by other users on the cloud server, and each user can learn how to troubleshoot the experience. Users can choose automatic scripts to solve system problems quickly and easily. The cloud service provided by the cloud server 10 is to provide experience in sharing/centrally debugging event logs and a method to solve problems.

Therefore, the disclosed log processing method can save manpower, can help users automatically filter the system and BMC event logs, quickly and easily automatically filter logs as to failures on the server, and then automatically analyze the logs and provide the best suggestions for event solutions. This will help users reduce debugging time and save time in data center debugging events.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A log processing method comprising:
collecting log as to abnormal events of an electronic device;
comparing the log with log data on a cloud server;
determining whether the log data matches the log, wherein the log data comprises a log description and a solution uploaded to the cloud server by one or more electronic devices; and
obtaining matched log data if the log data matches the log.

2. The log processing method according to claim 1, further comprising:
obtaining keywords of the log; and
comparing the keywords with the log description to determine whether a log description matches the log.

3. The log processing method according to claim 2, further comprising:
obtaining solution description and/or solution script corresponding to the matched log description if the log description matches the log.

4. The log processing method according to claim 3, further comprising:
detecting whether there is an execution instruction when the solution script is obtained; and
executing the solution script when the execution instruction is detected.

5. The log processing method according to claim 1, further comprising:
receiving the log description and the solution; and
uploading the log description and the solution to the cloud server when an upload instruction is detected, wherein the cloud server is a private cloud server or a public cloud server.

6. The log processing method according to claim 1, further comprising:
obtaining keyword text;
scanning the log to be tested and detecting latest event information of the log to be tested;
filtering out the log according to the keyword text; and
storing the abnormal log.

7. A log processing method comprising:
obtaining service access request sent by an electronic device; and
communicating with the electronic device according to the service access request, wherein the electronic device writes a log description and a solution; and/or the electronic device reads the log description and the solution.

8. An electronic device comprising:
a storage device; and
a processor,
wherein the storage device stores one or more programs, which when executed by the processor, cause the processor to:
collect log as to abnormal events of an electronic device;
compare the log with log data on a cloud server;
determine whether the log data matches the log; wherein the log data comprises a log description and a solution uploaded to the cloud server by one or more electronic devices; and
obtain matched log data if the log data matches the log.

9. The electronic device according to claim 8, wherein the processor is further caused to:
obtain keywords of the log; and
compare the keywords with the log description to determine whether a log description matches the log.

10. The electronic device according to claim 9, wherein the processor is further caused to:
obtain solution description and/or solution script corresponding to the matched log description if the log description matches the log.

11. The electronic device according to claim 10, wherein the processor is further caused to:
detect whether there is an execution instruction when the solution script is obtained; and
execute the solution script when the execution instruction is detected.

12. The electronic device according to claim 8, further causing the at least one processor to:
receive the log description and the solution; and
upload the log description and the solution to the cloud server when an upload instruction is detected, wherein the cloud server is a private cloud server or a public cloud server.

13. The electronic device according to claim 8, further causing the at least one processor to:
obtain keyword text;
scan the log to be tested and detecting latest event information of the log to be tested;
filter out the log according to the keyword text; and
store the log.

14. A cloud server comprising:
an obtaining module obtaining service access request sent by an electronic device; and
a response module communicating with the electronic device according to the service access request, wherein the electronic device writes a log description and a solution; and/or the electronic device reads the log description and the solution.
